(19) United States
(12) Patent Application Publication
(10) Pub. No.: US 2022/0235927 A1
(43) Pub. Date: Jul. 28, 2022

(54) LIGHTING APPARATUS

(71) Applicant: XIAMEN LEEDARSON LIGHTING CO.,LTD, Xiamen (CN)

(72) Inventors: Bin Yi, Xiamen (CN); Xiaoming Yang, Xiamen (CN); Zhongyuan Liang, Xiamen (CN); Zongyuan Liu, Xiamen (CN); Jiayuan Zhang, Xiamen (CN); Ruixiang Lin, Xiamen (CN); Yongzhe Dong, Xiamen (CN); Lei Zhang, Xiamen (CN); Hongwei Ge, Xiamen (CN); Zhirong Xie, Xiamen (CN); JunJie Lin, Xiamen (CN); Chuanbao Ye, Xiamen (CN)

(21) Appl. No.: 17/320,185

(22) Filed: May 13, 2021

(30) Foreign Application Priority Data
Jan. 26, 2021 (CN) 202120219734.4
Jan. 26, 2021 (CN) 202120219862.9
Jan. 26, 2021 (CN) 202120219913.8
Jan. 26, 2021 (CN) 202120219950.9

(51) Int. Cl. F21V 23/00; F21V 8/00

(52) U.S. Cl. CPC F21V 23/007; G02B 6/0088; G02B 6/0043; G02B 6/0076

(57) ABSTRACT

A lighting apparatus includes a first light source, a second light source, a first light guide plate, a second light guide plate and a driver. The first light source emits a first light. The second light source emits a second light. The first light guide plate receives the first light from a first lateral wall and guides the first light to escape via a first surface of the first light guide plate. The second light guide plate receives the second light and guides the second light to escape via a second surface of the second light guide plate. The second surface has an image pattern. The image pattern is rendered by placing multiple first light escaping dots on the second surface. The multiple first light escaping dots are divided into multiple sets for rendering multiple visual objects by arranging area intensities of the first light escaping dots.

### FIELD

The present invention is related to a lighting apparatus, and more particularly related to a lighting apparatus with visual effect.

### BACKGROUND

The time when the darkness is being lighten up by the light, human have noticed the need of lighting up this planet. Light has become one of the necessities we live with through the day and the night. During the darkness after sunset, there is no natural light, and human have been finding ways to light up the darkness with artificial light. From a torch, candles to the light we have nowadays, the use of light have been changed through decades and the development of lighting continues on.

Early human found the control of fire which is a turning point of the human history. Fire provides light to bright up the darkness that have allowed human activities to continue into the darker and colder hour of the hour after sunset. Fire gives human beings the first form of light and heat to cook food, make tools, have heat to live through cold winter and lighting to see in the dark.

Lighting is now not to be limited just for providing the light we need, but it is also for setting up the mood and atmosphere being created for an area. Proper lighting for an area needs a good combination of daylight conditions and artificial lights. There are many ways to improve lighting in a better cost and energy saving. LED lighting, a solid-state lamp that uses light-emitting diodes as the source of light, is a solution when it comes to energy-efficient lighting. LED lighting provides lower cost, energy saving and longer life span.

The major use of the light emitting diodes is for illumination. The light emitting diodes is recently used in light bulb, light strip or light tube for a longer lifetime and a lower energy consumption of the light. The light emitting diodes shows a new type of illumination which brings more convenience to our lives. Nowadays, light emitting diode light may be often seen in the market with various forms and affordable prices.

After the invention of LEDs, the neon indicator and incandescent lamps are gradually replaced. However, the cost of initial commercial LEDs was extremely high, making them rare to be applied for practical use. Also, LEDs only illuminated red light at early stage. The brightness of the light only could be used as indicator for it was too dark to illuminate an area. Unlike modern LEDs which are bound in transparent plastic cases, LEDs in early stage were packed in metal cases.

In 1878, Thomas Edison tried to make a usable light bulb after experimenting different materials. In November 1879, Edison filed a patent for an electric lamp with a carbon filament and keep testing to find the perfect filament for his light bulb. The highest melting point of any chemical element, tungsten, was known by Edison to be an excellent material for light bulb filaments, but the machinery needed to produce super-fine tungsten wire was not available in the late 19th century. Tungsten is still the primary material used in incandescent bulb filaments today.

Early candles were made in China in about 200 BC from whale fat and rice paper wick. They were made from other materials through time, like tallow, spermaceti, colza oil and beeswax until the discovery of paraffin wax which made production of candles cheap and affordable to everyone. Wick was also improved over time that made from paper, cotton, hemp and flax with different times and ways of burning. Although not a major light source now, candles are still here as decorative items and a light source in emergency situations. They are used for celebrations such as birthdays, religious rituals, for making atmosphere and as a decor.

Illumination has been improved throughout the times. Even now, the lighting device we used today are still being improved. From the illumination of the sun to the time when human can control fire for providing illumination which changed human history, we have been improving the lighting source for a better efficiency and sense. From the invention of candle, gas lamp, electric carbon arc lamp, kerosene lamp, light bulb, fluorescent lamp to LED lamp, the improvement of illumination shows the necessity of light in human lives.

There are various types of lighting apparatuses. When cost and light efficiency of LED have shown great effect compared with traditional lighting devices, people look for even better light output. It is important to recognize factors that can bring more satisfaction and light quality and flexibility.

Light devices are common in various places. Sometimes, in addition to luminance, people would like to have more functions.

For example, people may want to simulate a natural or an outdoor environment via their light devices.

It is therefore beneficial to design a light device with more functions to add flexibility of the light devices.

### SUMMARY

In some embodiments, a lighting apparatus includes a first light source, a second light source, a first light guide plate, a second light guide plate and a driver.

The first light source emits a first light.

The second light source emits a second light.

The first light guide plate receives the first light from a first lateral wall and guides the first light to escape via a first surface of the first light guide plate.

The second light guide plate receives the second light and guides the second light to escape via a second surface of the second light guide plate.

The second surface has an image pattern.

The image pattern is rendered by placing multiple first light escaping dots on the second surface.

The multiple first light escaping dots are divided into multiple sets for rendering multiple visual objects by arranging area intensities of the first light escaping dots.

The driver is coupled to the first light source and the second light source for controlling output of the first light and the second light.

In some embodiments, the second light guide plate has a third surface.

The third surface is opposite to the second surface.

There are multiple second light escaping dots disposed not the third surface.

The first light escaping dots are arranged with a misalignment to form a multi-layer visual effect.

In some embodiments, the multiple visual objects are clouds.

In some embodiments, the driver is controlled to change a color temperature of the first light source.

In some embodiments, the driver is controlled to change a color of the first light.

In some embodiments, the lighting apparatus may also include a third light guide plate stacked with the first light guide plate and the second light guide plate.

In some embodiments, the driver switches turning on a third light supplied to the third light guide plate and the second light to render an animation visual effect.

In some embodiments, the first light guide plate is placed above the second light guide plate, and the second light guide plate is placed above the third light guide plate.

In some embodiments, the driver changes an optical parameter of the first light along a predetermined time series.

In some embodiments, the driver changes the optical parameter of the first light to be corresponding to a weather and a location of a position deploying the lighting apparatus.

In some embodiments, the driver communicates with a portable device worn by a user and adjusts the first light source according to a biomedical information collected by the portable device.

In some embodiments, the second light source has two light strips disposed on opposite sides of the second light guide plate.

In some embodiments, the first light source and the second light source are integrated in a light strip.

In some embodiments, the first light escaping dots have multiple sizes.

In some embodiments, the first light guide plate and the second light guide plate are stacked with a gap.

In some embodiments, the lighting apparatus may also include a diffusion layer disposed between the first light guide plate and the second light guide plate.

In some embodiments, the lighting apparatus may also include a frame with an electrode to be connected to an adjacent lighting apparatus of the same type.

In some embodiments, the adjacent lighting apparatus and the lighting apparatus shares a power source.

In some embodiments, the adjacent lighting apparatus and the lighting apparatus are synchronized with a control commend sent to the driver.

In some embodiments, the first light source has multiple types of LED modules emitting different colors.

### BRIEF DESCRIPTION OF DRAWINGS

FIG. 1 illustrates an embodiment of a lighting apparatus.

FIG. 2 illustrates a cross-sectional view of the embodiment in FIG. 1.

FIG. 3 illustrates a detailed cross-sectional view of the embodiment in FIG. 1.

FIG. 4 illustrates another embodiment.

FIG. 5 illustrates an image pattern example with misalignment.

FIG. 6 illustrates multiple light escaping dots.

FIG. 7 illustrates a light source integrated with multiple types of LED modules.

FIG. 8 illustrates a stacked structure of multiple light guide plates.

FIG. 9 illustrates connecting multiple lighting apparatuses.

### DETAILED DESCRIPTION

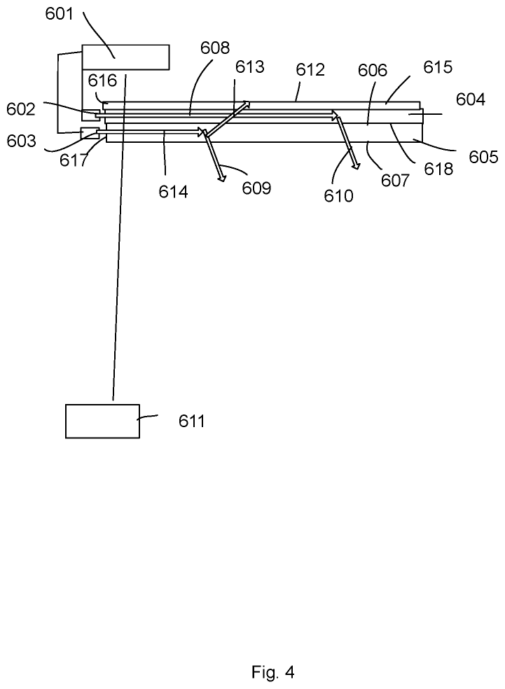

Please refer to FIG. 4, a lighting apparatus includes a first light source 602, a second light source 603, a first light guide plate 604, a second light guide plate 605 and a driver 601.

The first light source 602 emits a first light 608.

The second light source 603 emits a second light 614.

The first light guide plate 604 receives the first light 602 from a first lateral wall 616 and guides the first light 608 to escape via a first surface 618 of the first light guide plate 604.

The second light guide plate 605 receives the second light 614 and guides the second light 614 to escape via a second surface 607 of the second light guide plate 605.

The second surface 605 has an image pattern.

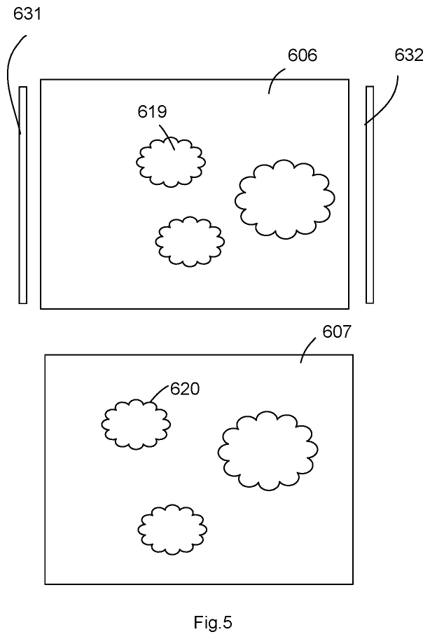

Please refer to FIG. 5. In FIG. 5, the second light guide plate has a second surface 607 and a third surface 608. In this example, both the second surface 607 and the third surface 608 have image patterns 619, 620.

The image pattern 619, 620 are rendered by placing multiple first light escaping dots on the second surface.

A light guide plate may be made of a transparent plate with lots of tiny light escaping dots, e.g. less than 1 mm diameter, formed by laser lights or mechanical cutting on a surface of the transparent plate. Light entering a lateral wall of such light guide plate escapes from these light escaping dots. By controlling distribution of the light escaping dots, different image patterns may be obtained. For example, these light escaping dots are formed with cloud shapes to emit a visual effect of a clouds.

In other embodiments, the light escaping dots may be arranged to simulate a fire or other image patterns.

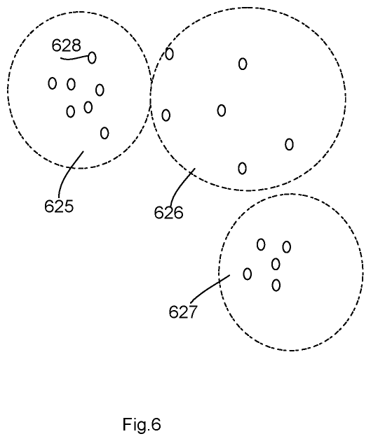

FIG. 6 shows an example of such light escaping dots. In FIG. 6, three visual objects 625, 626, 627 like clouds are formed on a second surface of the second light guide plate mentioned above. Each visual object corresponds to multiple light escaping dots 628.

The multiple first light escaping dots are divided into multiple sets for rendering multiple visual objects by arranging area intensities of the first light escaping dots.

In FIG. 4, the driver 601 is coupled to the first light source 602 and the second light source 603 for controlling output of the first light and the second light. The first light source 603 may be a light strip with a substrate mounted with multiple LED modules.

In some embodiments, the first light source and the second light source may respectively include multiple types of LED modules with different colors and/or color temperatures. By controlling the output of these different types of LED modules, different visual effect may be obtained, e.g. sunset sky or sky at the noon time.

In some embodiments, the second light guide plate has a third surface, as illustrated in FIG. 5. In FIG. 5, the second light guide plate has a second surface 606 and a third surface 607.

The third surface 606 is opposite to the second surface 607, on two opposite sides of the second light guide plate.

There are multiple second light escaping dots disposed not the third surface.

The first light escaping dots are arranged with a misalignment to form a multi-layer visual effect. In FIG. 5, the cloud shape image pattern 619 has a misalignment to the image pattern 620 so as to render a three-dimension visual effect. Under experiment, such visual effect appears more like real cloud because with depth information therein.

In some embodiments, the multiple visual objects are clouds.

In some embodiments, the driver is controlled to change a color temperature of the first light source.

In some embodiments, the driver is controlled to change a color of the first light.

In some embodiments, the lighting apparatus may also include a third light guide plate stacked with the first light guide plate and the second light guide plate.

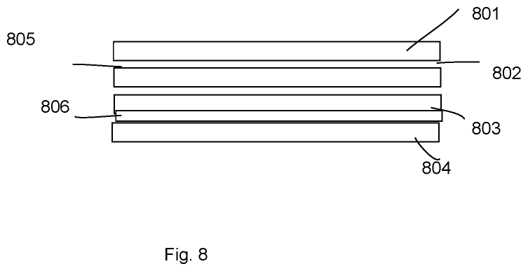

In FIG. 8, there are four light guide plates 801, 802, 803, 804. Three light guide plates 802, 803, 804 are added with image patterns. By controlling light input of these light guide plates, different visual effect is obtained. In some embodiments, the bottom light guide plate 804 may have no image pattern and when the bottom light guide plate is only used for emitting a light, users see a panel light without image patterns.

Corresponding light sources may be disposed for emitting lights into these light guide plates. In the mode to use the lighting apparatus as a simple panel light, other light sources are turned off. Therefore a switch may be used for switching between a simple panel light mode and a lighting apparatus with image patterns as mentioned above.

In some embodiments, the driver switches turning on a third light supplied to the third light guide plate and the second light to render an animation visual effect.

For example, two light guide plates with image patterns with misalignment are turned on by selectively providing lights into these light guide plates alternatively under a predetermined time series, an animation effect is simulated, e.g. a moving cloud.

In some embodiments, the first light guide plate is placed above the second light guide plate, and the second light guide plate is placed above the third light guide plate.

In some embodiments, the driver changes an optical parameter of the first light along a predetermined time series.

In some embodiments, the driver changes the optical parameter of the first light to be corresponding to a weather and a location of a position deploying the lighting apparatus.

For example, the driver may access environment data like dynamic weather information and position information and determines to simulate a light effect similar to outdoor environment.

Sound effects like thunder or raining may also be included by adding a speaker or sending sound information to a speaker by the driver.

The driver may receive an external command or execute a schedule control commands previously stored in a memory device in the lighting apparatus.

In FIG. 4, the driver communicates with a portable device 611, like a smart watch, worn by a user and adjusts the first light source according to a biomedical information collected by the portable device. For example, when users are tired and detected by the smart watch, the smart watch may send a command to the driver 601 to automatically adjust the color temperature of the lighting apparatus to provide a relaxing or an inspiring light effect.

In FIG. 5, the second light source has two light strips 631, 632 disposed on opposite sides of the second light guide plate. By disposing light strips 631, 632 on two sides or even four sides may enhance the visual effect particularly when the size of the lighting apparatus is bigger.

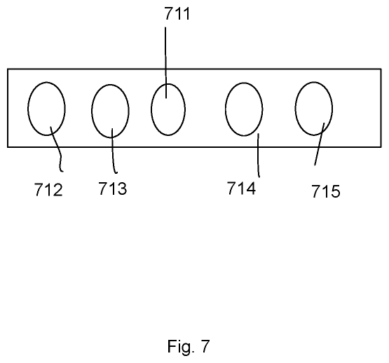

In FIG. 7, the first light source and the second light source 711 are integrated in a light strip. The second light source may include multiple types of LED modules 712, 713, 714, 715. For examples, they may include red, green, yellow lights to mix a desired sky background color.

In some embodiments, the first light escaping dots have multiple sizes. For example, the light escaping dots 628 may have different sizes to further randomize the visual effect to simulate natural objects like clouds.

In FIG. 8, the first light guide plate and the second light guide plate are stacked with a gap 805.

In FIG. 8, the lighting apparatus may also include a diffusion layer 806 disposed between the first light guide plate and the second light guide plate.

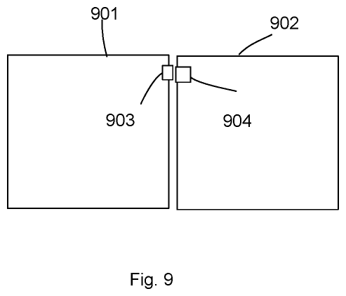

In FIG. 9, the lighting apparatus may also include a frame 901 with an electrode 903 to be connected to an adjacent lighting apparatus 902 of the same type that has a corresponding electrode 904. Such electrodes 903, 904 may be paired with plugging structures or connected with a connection wire.

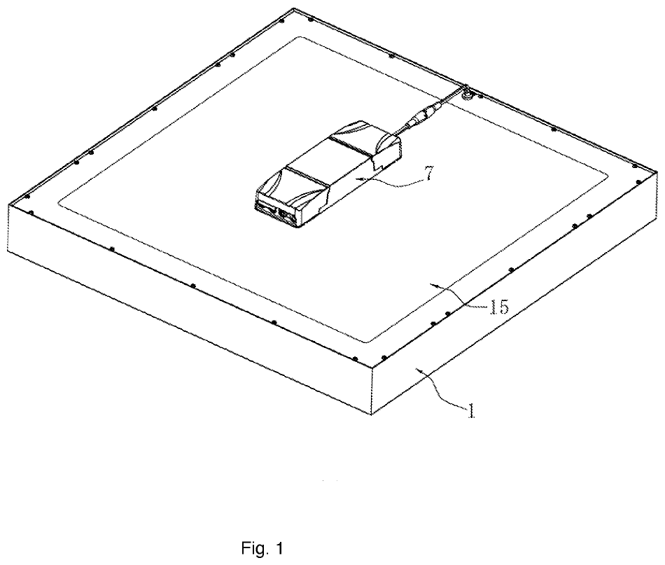

Please refer to FIG. 1. FIG. 1 illustrates a lighting apparatus embodiment 1 that has a back cover 15 and a driver 7.

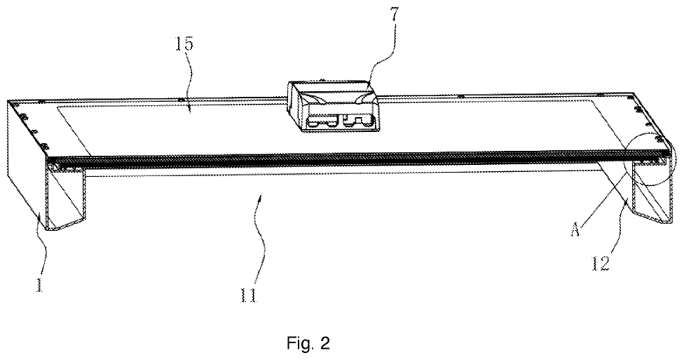

Please refer to FIG. 2, which illustrates a portion of the lighting apparatus 1 in FIG. 1.

In FIG. 2, there is a frame 12 with a depth for enhancing visual effect, like a window border. The light is moving downwardly via a light opening 11.

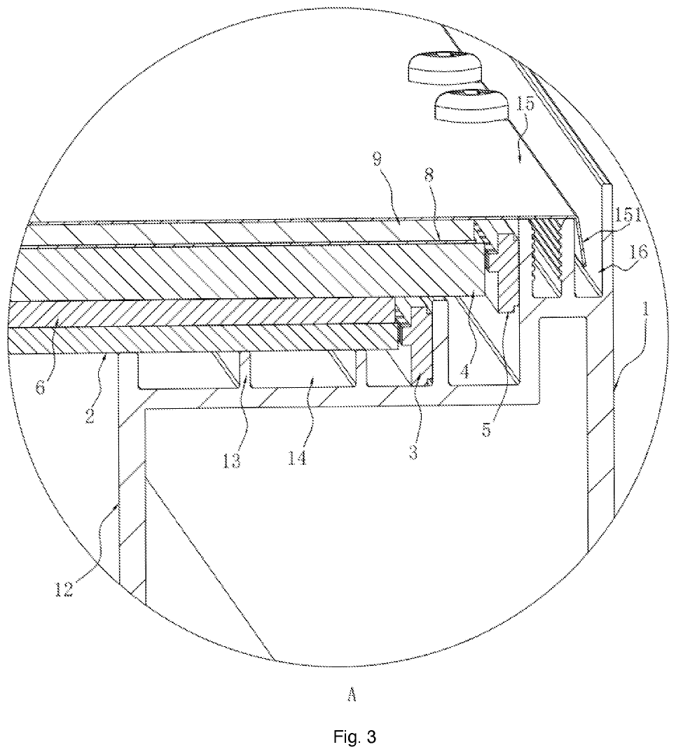

FIG. 3 illustrates a zoom-up view of the area A in FIG. 2.

In FIG. 3, there is an elastic layer 9 pressing a reflective layer 8. There is a first light guide plate 4 and a second light guide plate 2. A first light source 5 and a second light source 3 emit lights into the first light guide plate 4 and the second light guide plate 2. In this example, there is a diffusion layer 6.

The back cover 15 has a structure 151 for clipping the frame structure 16. Gaps 14 formed by the clipping structures 13 help stabilize the structure and enhance heat dissipation.

In some embodiments, the adjacent lighting apparatus and the lighting apparatus shares a power source. For example, a driver in one lighting apparatus provides electricity to another lighting apparatus. This is helpful when multiple lighting apparatuses are disposed to simulate a sky while decreasing overall cost.

In some embodiments, the adjacent lighting apparatus and the lighting apparatus are synchronized with a control commend sent to the driver. In such design, multiple lighting apparatuses to simulate a sky are controlled at the same time.

In some embodiments, the first light source has multiple types of LED modules emitting different colors for simulating different colors of a sky.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings.

The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

1. A lighting apparatus, comprising:
a first light source for emitting a first light;
a second light source for emitting a second light;
a first light guide plate for receiving the first light from a first lateral wall and guiding the first light to escape via a first surface of the first light guide plate;
a second light guide plate for receiving the second light and guiding the second light to escape via a second surface of the second light guide plate, wherein the second surface has an image pattern, the image pattern is rendered by placing multiple first light escaping dots on the second surface, the multiple first light escaping dots are divided into multiple sets for rendering multiple visual objects by arranging area intensities of the first light escaping dots, wherein the multiple visual objects are clouds; and
a driver coupled to the first light source and the second light source for controlling output of the first light and the second light, wherein the second light guide plate has a third surface, the third surface is opposite to the second surface, there are multiple second light escaping dots disposed on the third surface, the first light escaping dots are arranged with a misalignment to form a multi-layer visual effect.

2. (canceled)

3. (canceled)

4. The lighting apparatus of claim 1, wherein the driver is controlled to change a color temperature of the first light source.

5. The lighting apparatus of claim 1, wherein the driver is controlled to change a color of the first light.

6. The lighting apparatus of claim 1, further comprising a third light guide plate stacked with the first light guide plate and the second light guide plate.

7. The lighting apparatus of claim 6, wherein the driver switches turning on a third light supplied to the third light guide plate and the second light to render an animation visual effect.

8. The lighting apparatus of claim 6, wherein the first light guide plate is placed above the second light guide plate, and the second light guide plate is placed above the third light guide plate.

9. The lighting apparatus of claim 1, wherein the driver changes an optical parameter of the first light along a predetermined time series.

10. The lighting apparatus of claim 9, wherein the driver changes the optical parameter of the first light to be corresponding to a weather and a location of a position deploying the lighting apparatus.

11. The lighting apparatus of claim 1, wherein the driver communicates with a portable device worn by a user and adjusts the first light source according to a biomedical information collected by the portable device.

12. The lighting apparatus of claim 1, wherein the second light source has two light strips disposed on opposite sides of the second light guide plate.

13. The lighting apparatus of claim 1, wherein the first light source and the second light source are integrated in a light strip.

14. The lighting apparatus of claim 1, wherein the first light escaping dots have multiple sizes.

15. The lighting apparatus of claim 1, wherein the first light guide plate and the second light guide plate are stacked with a gap.

16. The lighting apparatus of claim 1, further comprising a diffusion layer disposed between the first light guide plate and the second light guide plate.

17. The lighting apparatus of claim 1, further comprising a frame with an electrode to be connected to an adjacent lighting apparatus of the same type.

18. The lighting apparatus of claim 17, wherein the adjacent lighting apparatus and the lighting apparatus shares a power source.

19. The lighting apparatus of claim 17, wherein the adjacent lighting apparatus and the lighting apparatus are synchronized with a control command sent to the driver.

20. The lighting apparatus of claim 1, wherein the first light source has multiple types of LED modules emitting different colors.
